(19) United States
(12) Patent Application Publication
(10) Pub. No.: US 2005/0174882 A1
(43) Pub. Date: Aug. 11, 2005

(54) Combination mixing and drinking vessel

(76) Inventors: Mark T. Krasne, Kansas City, MO (US); Duane Smith, Shawnee, KS (US); William S. Endres, Leawood, KS (US); Jimmy Yung Siu Yim, Hong Kong (HK)

Correspondence Address: HOVEY WILLIAMS LLP, 2405 GRAND BLVD., SUITE 400, KANSAS CITY, MO, 64108, US

(21) Appl. No.: 10/775,005

(22) Filed: Feb. 9, 2004

(51) Int. Cl. B01F 7/00

(52) U.S. Cl. 366/249; 366/251

(57) ABSTRACT

The vessel has an open top receptacle that is provided with a drink-through cap unit removably secured to the upper end of the receptacle. The cap unit includes a cap and a battery-powered mixer incorporated into the cap. An elongated mixing element of the mixer projects downwardly from the cap into the receptacle for agitating and mixing the contents when a switch on the cap is actuated by the user. Without removing the cap unit from the receptacle after mixing, the user may drink the contents directly from a lip on the drink-through cap. A stopper for the drinking orifice in the cap may be mounted on a rockable operating lever that is easily manipulated by the user between open and closed positions.

### TECHNICAL FIELD

The present invention relates to drinking receptacles, and more particularly, to a special receptacle provided with a drink-through cap and a built-in mixer for stirring and mixing contents of the vessel before they are consumed.

### BACKGROUND AND SUMMARY

Many drinks consumed by health-conscience individuals and the general public today are prepared from mixes. Some may be a combination of ingredients in powder form mixed with a liquid base, while others may comprise a mixture of different liquids. Diet drinks, fitness drinks, supplements and shakes of various kinds are typically prepared by adding the ingredients into a blender or other mixing device, mixing the ingredients together, and then transferring the drink to a selected drinking vessel. In some instances the drink may be prepared in the same vessel from which the drink will be consumed, using a portable mixer of some type or a suitable implement such as a spoon or spatula.

The present invention is directed to a special drinking vessel having a built-in mixer so that the constituents of the drink may be conveniently mixed and consumed from the very same vessel. The mixer is an integral part of the vessel itself and is thus adapted to remain in place during consumption of the drink; yet the mixer is so configured, arranged, and located that it does not interfere in any way with drinking directly from the vessel. Moreover, the integrated design permits the ingredients to be remixed periodically if necessary or desired without transferring the preparation back to a mixing vessel or inserting a separate mixer into the vessel.

In a preferred form of the invention, the combination mixing and drinking vessel comprises an open top receptacle that has a removable cap unit closing the open top of the receptacle. The cap unit includes a drink-through type cap provided with an orifice through which the contents of the receptacle may be dispensed when the vessel is tipped up.

The cap unit further includes a built-in, battery-powered mixer having a mixing or stirring element projecting downwardly from the cap and into the interior of the receptacle when the cap unit is secured in place at the top end of the receptacle. A finger-actuated switch on the cap enables the user to turn the stirring element off and on while the cap unit covers the contents to prevent splashing. Preferably, the cap unit also includes a stopper for the drinking orifice that can be easily manipulated by the user between orifice-opening and closing positions. In a most preferred form of the invention, the mixer switch and the stopper are ergonometrically configured and arranged to facilitate manipulation by the user.

### BRIEF DESCRIPTION OF THE DRAWINGS

FIG. 1 is a top isometric view of a combination mixing and drinking vessel in accordance with the present invention;

FIG. 2 is an exploded isometric view of the major components of the vessel;

FIG. 3 is an enlarged vertical cross-sectional view of the vessel showing the stopper in its closed position sealing the dispensing orifice in the cap of the vessel;

FIG. 4 is a fragmentary cross-sectional view of the vessel similar to FIG. 3 but showing the stopper in its open position allowing the contents of the receptacle to be dispensed when the vessel is up-ended;

FIG. 5 is a further enlarged cross-sectional view of the vessel rotated 90° from the FIGS. 3 and 4 positions to reveal internal details of the mixer actuating switch and the interlock switch that prevents the mixer from being engaged when the cap unit is removed from the receptacle;

FIG. 6 is a fragmentary bottom view of the lid for the battery compartment of the cap unit taken substantially along sight line 6-6 of FIG. 4; and

FIG. 7 is an enlarged fragmentary detail view of one fulcrum pivot associated with the stopper operating lever of the cap unit.

### DETAILED DESCRIPTION

The present invention is susceptible of embodiment in many different forms. While the drawings illustrate and the specification describes certain preferred embodiments of the invention, it is to be understood that such disclosure is by way of example only. There is no intent to limit the principles of the present invention to the particular disclosed embodiments.

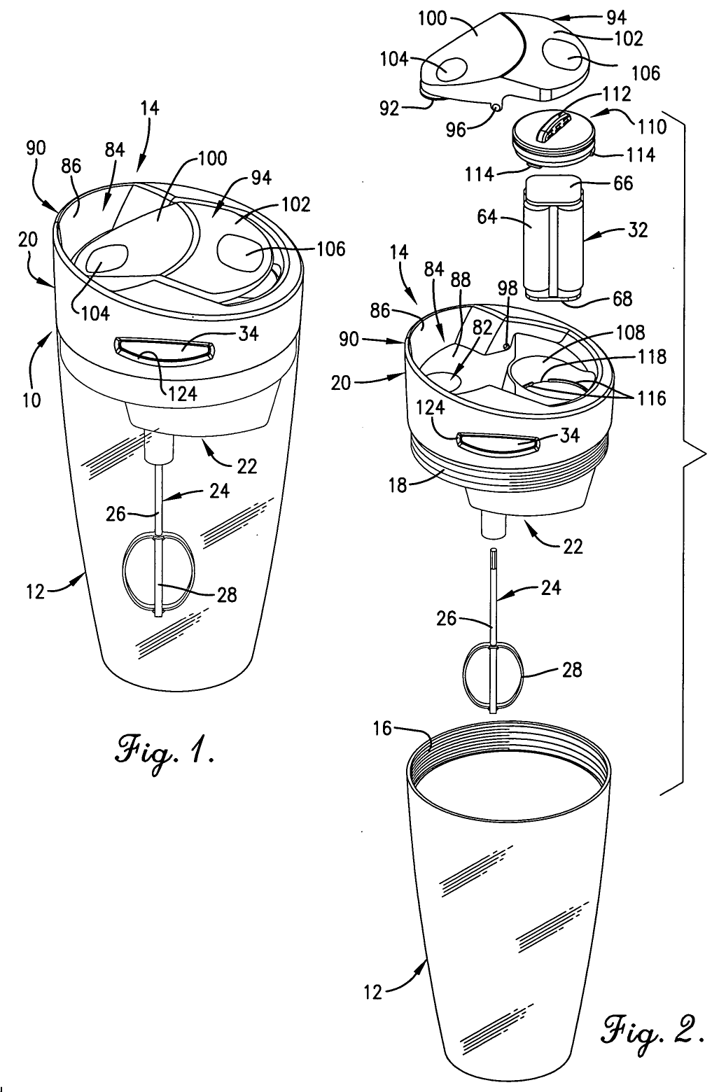

Beginning initially with FIGS. 1 and 2, it will be seen that the combination mixing and drinking vessel 10 of the present invention includes two primary components, i.e., an open top receptacle 12 and a closure cap unit 14 removably secured to the top end of receptacle 12. Receptacle 12 has a set of internal threads 16 at its upper end that are adapted to interengage with a set of external threads 18 on cap unit 14 to serve as the means for removably attaching cap unit 14 to receptacle 12. Receptacle 12 may be constructed from any suitable material, but is preferably transparent or translucent so that the contents thereof may be visually observed from outside receptacle 12 both during mixing operations and otherwise.

The cap unit 14 includes a cap broadly denoted by the numeral 20 and a mixer broadly denoted by the numeral 22. A mixing or stirring element 24 comprises a part of mixer 22 and projects downwardly from cap 20 and into the interior of receptacle 12 when cap unit 14 is threaded onto the upper end of receptacle 12. Mixing element 24 may take a variety of different shapes, but in a preferred form includes a central shank 26 having a pair of generally elliptical-shaped, rigid loops 28 at its lower end. Mixing element 24 is adapted for rotation about the longitudinal axis of shank 26, which axis is somewhat eccentrically exposed with respect to the axis of symmetry of receptacle 12. Thus, mixing element 24 is preferably somewhat closer to one side of receptacle 12 than the other.

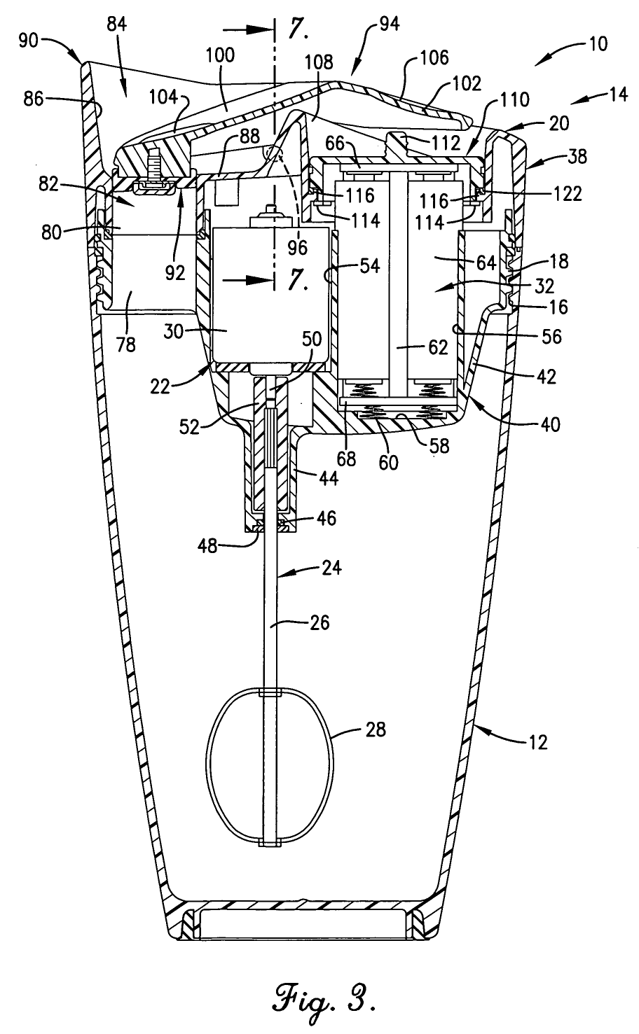

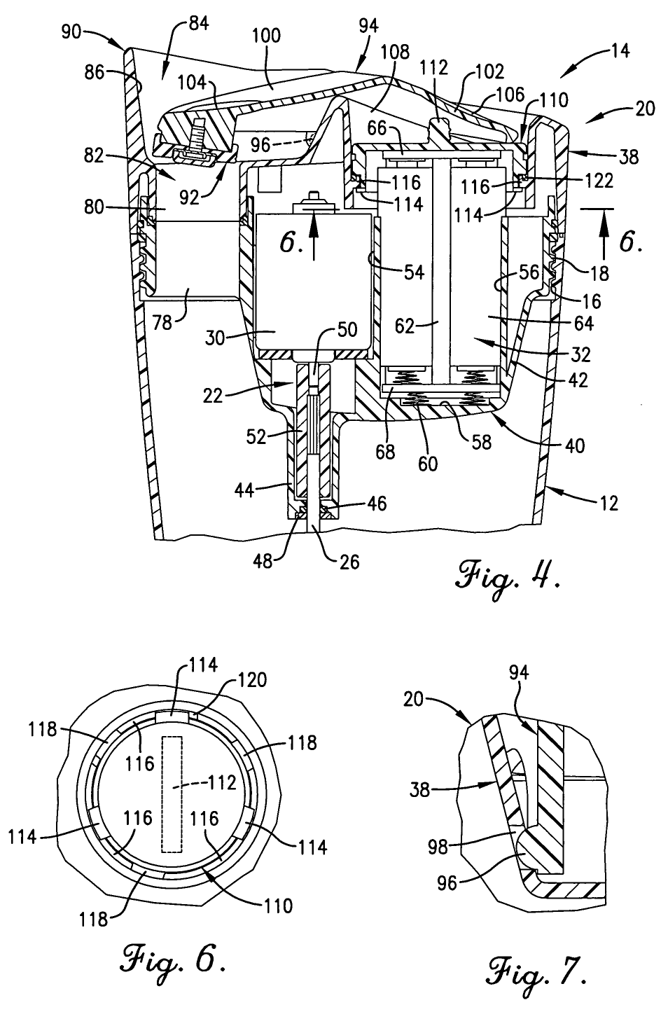

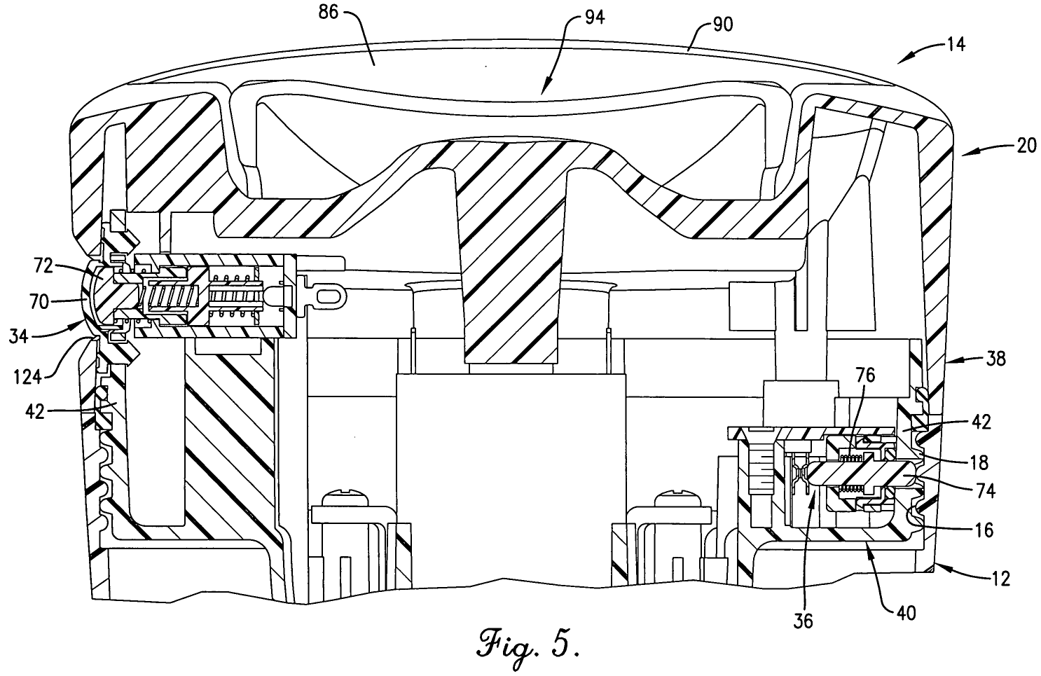

In addition to mixing element 24, the mixer 22 includes a battery-powered motor 30 (FIGS. 3 and 4), a battery pack 32 for supplying electrical power to motor 30, and a main switch 34 electrically connected in a circuit with motor 30 and battery pack 32 for actuating and deactuating mixing element 24. Additionally, mixer 22 includes a safety interlock switch 36 (FIG. 5) that is series-connected in the circuit with motor 30, battery back 32, and main switch 34 for disabling the circuit whenever cap unit 14 is removed from receptacle 12. As will be subsequently explained in more detail, when cap unit 14 is threaded onto receptacle 12, the internal threads 16 of receptacle 12 are operable to close interlock switch 36 to enable the circuit to be energized when main switch 34 is appropriately operated.

The cap 20 of cap unit 14 is formed in two halves, comprising a downwardly opening upper cup 38 and an upwardly opening lower cup 40. Upper and lower cup 38, 40 are secured together by means not shown to provide a generally hollow interior to the cup 20 within which various components of the mixer 22 are housed. Lower cup 40 has a sidewall 42 provided with a generally cylindrical portion at its upper end within which the exterior threads 18 are formed. The lower portion of sidewall 42 is somewhat bowl-shaped and is provided with a depending, integral, rigid tube 44 that houses the upper end of shank 26 of mixing element 24. An O-ring 46 within the lower end of tube 44 surrounds shank 26 and sealingly contacts the same to prevent ingress of liquid into the interior of lower cup 40 via tube 44, and an annular retainer 48 beneath O-ring 46 keeps O-ring 46 in place within tube 44.

The upper end of shank 26 is operably coupled with a depending output shaft 50 of motor 50 by a cylindrical coupling sleeve 52 that receives output shaft 50 at one end and shank 26 of mixing element 24 at the other end. Motor 30 is received within a cylindrical motor compartment 54 defined within the lower cup 40 in axial alignment with tube 44.

Lower cup 40 is also configured internally to define a battery compartment 56 that removably receives battery pack 32. The upper end of compartment 32 is open such that battery pack 32 projects above and beyond the same, but the lower end is closed, presenting a floor 58 having two or more coil compression springs 60 projecting upwardly therefrom for resiliently engaging the bottom of battery pack 32 when the latter is received within chamber 56. As well understood by those skilled in the art, battery pack 32 includes a carrier 62 designed to preferably receive four cylindrical storage batteries 64 that are confined between upper and lower end plates 66 and 68 respectively of carrier 62, the end plates 66, 68 being provided with suitable means for establishing electrical continuity in series between the storage batteries 64 and with the rest of the mixer circuit.

With reference to FIG. 5, it will be seen that one portion of sidewall 42 of lower cup 40 is adapted to support portions of the main switch 34 of mixer 22. In this regard, sidewall 42 carries a resilient, flexible membrane 70 preferably of rubberized material that overlies an actuating button 72 of switch 34. Switch 34 may comprise any one of a large number suitable switches well understood by those of skill in the art. In one preferred form, switch 34 is of the type requiring two successive depressions of button 72 in order to close and then reopen the circuit controlled by switch 34. Thus, a single depression of button 72 will engage mixer motor 30 and continue operation of mixing element 24 until such time as button 72 is again depressed, whereupon motor 30 will be disengaged and mixing element 24 will stop rotating.

Diametrically opposed to main switch 34 is the interlock switch 36 which is also supported within lower cup 40, particularly sidewall 42 thereof. Unlike main switch 34, interlock switch 36 has an actuating button 74 that closes the operating circuit for motor 30 whenever button 74 is maintained in a depressed condition, such as illustrated in FIG. 5. The internal threads 16 on receptacle 12 are operable to engage and maintain button 74 in such depressed position when cap unit 14 is fully threaded onto receptacle 12; on the other hand, when cap unit 14 is removed from receptacle 12, a return spring 76 associated with button 74 shifts the latter radially outwardly to open the circuit such that motor 30 may not be inadvertently energized even when main switch 34 is depressed. Switch 36 may take the form of any number of readily commercially available interlock switches well known to those skilled in the art.

Referring once again to FIGS. 3 and 4, it will be seen that lower cup 40 is also formed to present a lower cylindrical passage 78 that cooperatively registers with a similar overhead passage 80 in the upper cup 38 to define a dispensing orifice 82 in cap 20 that is visible also in FIG. 2. Orifice 82 thus adapts cap 20 to serve as a drink-through cap, permitting the contents of receptacle 12 to be consumed by up-ending vessel 10 and pouring the contents out through orifice 82.

Orifice 82 is defined within a basin 84 formed within the top exterior of upper cup 38 of cup 20. Basin 84 is produced in part by an upstanding, arcuate peripheral sidewall 86 rising from a floor 88. Sidewall 86 is disposed in close proximity to orifice 82 and serves as a drinking lip denoted broadly by the numeral 90 over which the contents of receptacle 12 may be poured when vessel 10 is up-ended and orifice 82 is open. Preferably, although not necessarily, sidewall 86 is so configured that it is taller in the vicinity of orifice 82 than in other regions of cap 20 so as to facilitate drinking from lip 90.

Orifice 82 is preferably provided with a stopper 92 so that orifice 82 may be selectively opened and closed. In a preferred form of the invention, stopper 92 comprises a resilient cylindrical disk of suitable synthetic resinous material having an outer diameter that is substantially equal to or slightly greater than the internal diameter or orifice 82 such that stopper 92 may be securely wedged within the upper extremity of orifice 82 for sealing purposes. Stopper 92 may be slightly tapered to facilitate entry into and sealing of orifice 82.

Preferably, stopper 92 is mounted on an operating lever 94 that is pivotally secured to upper cup 38 for rocking movement between open and closed positions as illustrated in FIGS. 4 and 3. Operating lever 94 is slightly convexly arched and is provided with a pair of oppositely laterally outwardly projecting pivot pins 96 (FIGS. 2, 3, 4 and 7) that are pivotally received within mating holes 98 in sidewall 86 to define a fulcrum point for lever 94. Pins 96 removably snap into receiving holes 98 so as to permit operating lever 94 to be selectively removed if desired for cleaning purposes. The oppositely downsloping upper surfaces of lever 94 on opposite sides of the fulcrum formed by pins 96 serve as manually depressible portions 100 and 102 of lever 94 and are preferably provided with shallow finger-engageable depressions 104 and 106 to facilitate manual actuation.

The upper cup 38 of cap 20 is provided with a cylindrical well 108 that underlies rear portion 102 of operating lever 94 and is disposed in axial registration with battery compartment 56 in the lower cup 40. Well 108 is dimensioned to receive a disk-like lid 110 for battery compartment 56. Lid 110 has a transverse, upstanding rib 112 on its upper surface that serves as a finger grip for manipulation purposes.

Access to lid 110 is made available when operating lever 94 is removed by disengaging its pivot pins 96 from the receiving holes 98. Lid 110 is adapted to be locked in place and released therefrom using a turning motion within the well 108. In this respect, lid 110 is provided with three radially outwardly projecting locking tabs 114 at 120° intervals around its lower extremity (see also FIG. 6). Three arcuate ledges 116 are located near the bottom extremity of well 108 and project radially inwardly from the sidewall of well 108 for a short distance. Ledges 116 are separated by three notches 118 corresponding in size and spacing to the locking tabs 114. The outer diameter of lid 110 across the locking tabs 114 corresponds to the internal diameter of well 108, while the inside diameter of well 108 between ledges 116 is less than the diameter across tabs 114. Thus, tabs 114 can only pass upwardly or downwardly by ledges 116 when tabs 114 are aligned with notches 118. Once tabs 114 are below ledges 116, lid 110 may be rotated a short distance in an appropriate direction to bring one of the tabs 114 against a stop 120 (FIG. 6), precluding further rotation of lid 110 in that direction. With tabs 114 thus disposed beneath and in registration with ledges 116, the lid 110 is prevented from being axially withdrawn up out of well 108.

The depth of well 56 is such that in order to lock lid 110 down into its locked position of FIGS. 3 and 4, the carrier 62 of battery back 32 must be depressed by lid 110 against the action of springs 60 at the bottom of compartment 56, and this upward bias by springs 60 against lid 110 when the latter is in its locked position forces the locking tabs 114 into abutting engagement with the underside of ledges 116 so as to assist in retaining lid 110 in its locked position. An O-ring seal 122 is pressed between the upper surfaces of ledges 116 and the bottom surface of an overhanging portion of lid 110 to seal battery compartment 56 against the entry of moisture when lid 110 is locked down within well 108.

Preferably, cap 20, operating lever 94 and lid 110 are molded from a suitable synthetic resinous material to facilitate manufacture and periodic cleaning. A window 124 is formed in the sidewall of cap 20 in registration with main switch 34 for the purpose of providing operating access thereto by the user's thumb or fingers.

Operation

The manner of use and operation of vessel 10 should be apparent from the foregoing description. With the cap unit 14 unscrewed from receptacle 12 and set to one side, receptacle 12 may be filled with a preferred liquid and other ingredients, whether in powdered or liquid form. The cap unit 14 is then placed on the top of receptacle 12 with mixing element 24 inserted downwardly into the contents. By screwing cap unit 14 down into place, the interlock switch 36 becomes depressed by the internal threads 16 of receptacle 12, enabling the mixer circuit. With the operating lever 94 depressed in the appropriate direction to cause stopper 92 to seal orifice 82 as illustrated in FIG. 3, the user may then depress main switch 34, energizing mixing element 24 and causing the ingredients within receptacle 12 to become fully mixed and blended together. Once the ingredients have been mixed together to the desired extent, the user again depresses switch 34 to turn off mixing element 24.

Without removing cap unit 14, the user may then depress the rear portion 102 of operating lever 94 to disengage stopper 92 from orifice 82 as illustrated in FIG. 4. Vessel 10 may then be raised to the user's mouth and up-ended to the extent necessary to cause the contents to pour out of orifice 82 into basin 84 and over the lip 90. Notwithstanding the presence of operating lever 94 within basin 84, lip 90 on cap 20 is sufficiently high as to avoid any interference from operating lever 94 as the user drinks from the vessel. Stopper 92 may be readily replaced within orifice 82 at any time by simply depressing the front portion 100 of operating lever 94.

After the contents of vessel 10 have been consumed, cap unit 14 may be easily removed from receptacle 12 by simply unscrewing unit 20. Thereupon, both cap unit 14 and receptacle 12 may be easily cleaned and set aside in preparation for subsequent mixing and drinking operations. It will be seen that by having a mixer incorporated into the drink-through cap in such a way that the mixer in no way interferes with the user's ability to drink from the cap, a great convenience is obtained.

The inventor(s) hereby state(s) his/their intent to rely on the Doctrine of Equivalents to determine and assess the reasonably fair scope of his/their invention as pertains to any apparatus not materially departing from but outside the literal scope of the invention as set out in the following claims.

1. A combination mixing and drinking vessel comprising:
a receptacle having an open top; and
a closure cap unit detachably secured to the receptacle in a position closing said open top,
said closure cap unit including a cap and a mixer supported by the cap,
said mixer having an actuatable mixing element extending down into the receptacle from the cap,
said cap having an orifice through which the contents of the receptacle may be discharged when the vessel is upended.

2. A combination mixing and drinking vessel as claimed in claim 1,
said closure cap unit further including a stopper movable between positions opening and closing said orifice.

3. A combination mixing and drinking vessel as claimed in claim 2,
said stopper comprising part of an operating lever pivotally mounted on the cap for rocking movement about a fulcrum to shift the stopper between its open and closed positions,
said lever including manually depressible portions on opposite sides of said fulcrum for actuating the lever,
said stopper being disposed on one of said depressible portions.

4. A combination mixing and drinking vessel as claimed in claim 3,
said cap having a basin including a floor and sidewalls projecting upwardly from the floor at the periphery of the basin,
said orifice being located in said floor,
one of said sidewalls comprising part of a pouring lip on the cap.

5. A combination mixing and drinking vessel as claimed in claim 4,
said one depressible portion of the operating lever being received within said basin,
said basin and said one depressible portion of the operating lever being configured and arranged such that the operating lever does not interfere with drinking from the pouring lip when the stopper is in its open position.

6. A combination mixing and drinking vessel as claimed in claim 1,
said mixer further including an electrically powered motor for driving said mixing element, a battery for said motor, and a selectively operable switch for electrically connecting and disconnecting the motor from said battery.

7. A combination mixing and drinking vessel as claimed in claim 6,
said cap having a compartment for receiving said battery and a removable lid for confining the battery within the compartment.

8. A combination mixing and drinking vessel as claimed in claim 7,
said closure cap unit further including a stopper movable between positions opening and closing said orifice.

9. A combination mixing and drinking vessel as claimed in claim 8,
said stopper comprising part of an operating lever that may be rocked about a fulcrum to shift the stopper between its open and closed positions,
said lever including a pair of manually depressible portions on opposite sides of said fulcrum for actuating the lever,
said stopper being disposed on one of said depressible portions,
the other of said depressible portions overlying said battery compartment.

10. A combination mixing and drinking vessel as claimed in claim 9,
said cap having a basin including a floor and sidewalls projecting upwardly from the floor at the periphery of the basin,
said orifice being located in said floor,
one of said sidewalls of the basin comprising part of a pouring lip on the cap.

11. A combination mixing and drinking vessel as claimed in claim 10,
said one depressible portion of the operating lever being received within said basin,
said basin and said one depressible portion of the operating lever being configured and arranged such that the operating lever does not interfere with drinking from the pouring lip when the stopper is in its open position.

12. A combination mixing and drinking vessel as claimed in claim 6,
said mixer further including an electrical interlock switch operable to interrupt electrical power to the motor when the cap unit is detached from the receptacle.

13. A combination mixing and drinking vessel as claimed in claim 1,
said cap having a basin including a floor and sidewalls projecting upwardly from the floor at the periphery of the basin,
said orifice being located in said floor,
one of said sidewalls comprising part of a pouring lip on the cap.

14. A combination mixing and drinking vessel as claimed in claim 13,
said closure cap unit further including a stopper movable between positions opening and closing said orifice.
